(19) United States
(12) Patent Application Publication
(10) Pub. No.: US 2008/0081001 A1
(43) Pub. Date: Apr. 3, 2008

(54) MEDIUM FOR ANALYSIS HAVING A FLOW CHANNEL FOR A FLUID SPECIMEN AND A METHOD OF FLOWING THE FLUID SPECIMEN

(75) Inventors: Takashi Ishiguro, Gunma (JP); Naoto Hagiwara, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 11/861,192

(22) Filed: Sep. 25, 2007

(30) Foreign Application Priority Data
Sep. 26, 2006 (JP) 2006-289224

(51) Int. Cl. B01J 19/00

(52) U.S. Cl. 422/68.1; 137/1

(57) ABSTRACT

A medium for analysis capable of conducting processing such as synthesis reaction, mixing, or centrifugation by a simple structure, and a method of conducting processing such as synthesis reaction, mixing, or centrifugation by using the medium for analysis, are disclosed. In one aspect, the medium for analysis is formed with an analysis part including a liquid storage part for storing and supplying a fluid specimen and a channel extending from the liquid storage part in the centrifugal direction and closed at the final end thereof to a substrate formed rotatably.

### BACKGROUND OF THE INVENTION

1. Field of the Invention

The present invention concerns a medium for analysis having a rotatable structure in which a flow channel for a fluid specimen is disposed at the surface or the inside, as well as a method of flowing the fluid specimen in the flow channel for processing the fluid specimen by using the medium for analysis.

2. Description of the Related Technology

JP-T-2000-514928 discloses a device of utilizing centripetal acceleration for driving the streaming movement in a micro fluidics system. It has been proposed to use such a device for microanalysis or microsynthesis and microanalysis in medical, biological and chemical fields.

In the device described above, a disk in which fine capillary channels are formed, a fluid specimen is caused to flow in the channels during which synthesis reaction, analysis, or measurement is conducted. The device utilizes centrifugal force generated by the rotation of the disk as a method of flowing the fluid specimen.

Further, for controlling the flow of the fluid specimen caused by the centrifugal force the configuration of the channels is designed so as to be suitable to processing such as synthesis reaction or mixing. Further, for smooth flow of the fluid specimen in the channel, an air vent hole is disposed to the final end of the channel.

However, in the device described above, since only the flow of a liquid caused by the centrifugal force is utilized, the configuration of the channel for controlling the flow of the fluid specimen so as to be suitable to processing such as synthesis reaction or mixing is complicated tending to make the design troublesome.

### SUMMARY OF CERTAIN INVENTIVE ASPECTS

Certain inventive aspects relate to a medium for analysis capable of conducting processing such as synthesis reaction, mixing, or centrifugal separation by a simple structure and a method of simply conducting processing such as synthesis reaction, mixing, or centrifugal separation by using the medium for analysis.

The invention provides, in a first aspect, a medium for analysis formed with one or more analysis parts each having a liquid storage part for storing and supplying a fluid specimen and a channel extending from the liquid storage part in the centrifugal direction on the surface or the inside of a substrate formed rotatably, in which the final end of the channel is closed, and a gas storage part for storing a gas in the final end of the channel upon injection of a fluid specimen to the liquid storage part is formed.

Further, a medium for analysis wherein the analysis part is formed in plurality, and the liquid storage part of each of the analysis parts is connected by a liquid feeding passage is provided.

According to the first aspect of the invention, since the gas in the gas storage part has an effect of repelling the fluid specimen in the channel, it can retain and further backwardly flow the fluid specimen generated by the centrifugal force. By the effect, the flow of the fluid specimen can be controlled. Further, by forming a plurality of the analysis parts and connecting the liquid storage part of each of the analysis parts by the liquid feeding passage, a plurality of analyzing processes can be conducted at once for an identical fluid specimen.

The invention provides, in a second aspect, a medium for analysis wherein the gas storage part is formed of a space of a width larger than that of the channel. According to the second aspect of the invention, since the amount of the gas stored in the gas storage part is increased, the flowing amount of the entering fluid specimen can be increased and, further, the volume of the fluid specimen to flow backwardly is increased more. Further, the fluid specimen can be stored finally.

The invention provides, in a third aspect, a medium for analysis wherein a retainer portion for staying the fluid specimen is formed between the liquid storage part and the gas storage part. According to the aspect of the invention, processing such as synthesis reaction and mixing can be conducted in the retainer portion and various measurements can be conducted therein. Further, by the provision of a reagent injection part, the fluid specimen and the reagent can be mixed.

Further, the invention provides, in a fourth aspect, a medium for analysis wherein a bend section is provided between the liquid storage part and the gas storage part. According to the fourth aspect of the invention, since the direction of the centrifugal force and the direction of the liquid flow are changed by the bend section, the fluid specimen reaching the gas storage part can be retained near the channel and, further, also the fluid specimen entering the gas storage part can be returned to the channel upon backward flow.

Further, another inventive aspect relates to a method of flowing a fluid specimen by using a medium for analysis formed with one or more analysis parts each having a liquid storage part for storing and supplying a fluid specimen and a channel extending from the liquid storage part in the centrifugal direction on the surface or the inside of a substrate formed rotatably, and the final end of the channel is closed, and flowing the fluid specimen by centrifugal force, wherein the fluid specimen in the channel is caused to flow backwardly by decelerating the rotational speed of the medium for analysis. This enables backward flow of the fluid specimen which could not be attained so far and processing such as synthesis reaction, mixing, or centrifugal separation can be conducted by a simple method without using a medium for analysis formed with complicate channels.

Furthermore, another inventive aspect relates to a flowing method of a fluid specimen of repeating acceleration and deceleration for the rotational speed of the medium for analysis alternately. This enables to conduct synthesis reaction, etc. requiring repetitive processing by a medium for analysis of a simple structure.

Another inventive aspect relates to a method capable of obtaining a medium for analysis that can conduct processing such as synthesis reaction, mixing, or centrifugal separation by a simple structure and, further, conduct processing such as synthesis reaction, mixing, or centrifugal separation simply by using the medium for analysis.

### BRIEF DESCRIPTION OF THE DRAWINGS

FIG. 1 is a schematic plan view showing a first embodiment of a medium for analysis;

FIG. 2 is an enlarged view for an analysis part 3;

FIG. 3 is a schematic plan view showing a second embodiment of a medium for analysis;

FIG. 4 is an enlarged view for an analysis part 3a;

FIG. 5 is a schematic plan view showing a third embodiment of a medium for analysis;

FIG. 6 is an enlarged view for an analysis part 3b;

FIG. 7 is an enlarged view showing another example of the synthesis part 3b;

FIG. 8 is a schematic plan view showing a fourth embodiment of a medium for analysis;

FIG. 9A is a view showing the effect by a bend section and FIG. 9B is a view showing a case of disposing a partition in a gas storage part;

FIG. 10 is a schematic plan view showing a fifth embodiment of a medium for analysis;

FIG. 11 is a schematic cross sectional view along line X-X in FIG. 10; and

FIG. 12 is a schematic plan view showing another example of a fifth embodiment of a medium for analysis.

### DESCRIPTION OF CERTAIN EMBODIMENTS

A preferred embodiment of a medium for an analysis and a flowing method of a fluid specimen according to the invention is to be described with reference to the drawings.

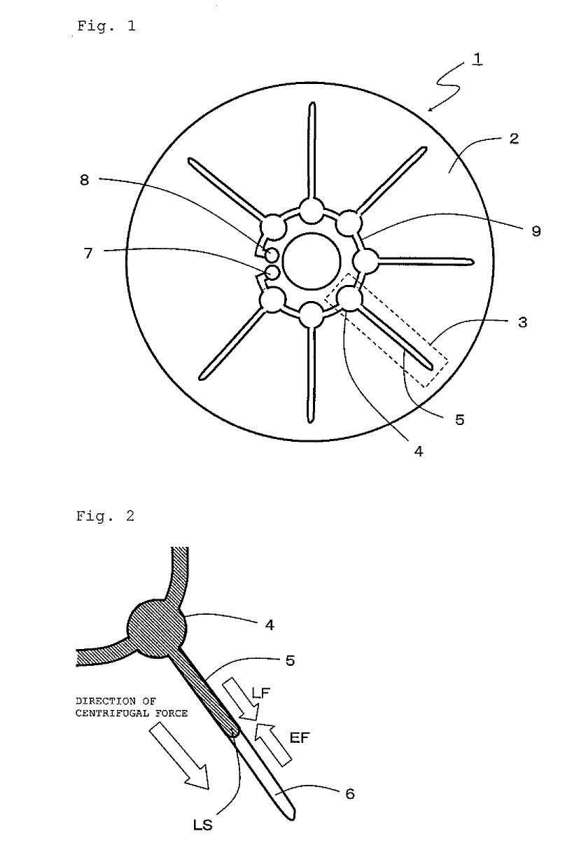

FIG. 1 is a plan view schematically showing the first embodiment of the medium for analysis of the invention. The medium 1 for analysis is formed with an analysis part 3 having a liquid storage part 4 for storing and supplying a fluid specimen, and a channel 5 extending from the liquid storage part 4 in the centrifugal direction, that is, in the direction receding from the rotational axis and closed at the final end thereof. While the analysis part 3 may be formed by one, it may be formed in plurality, preferably, by three or more while considering the balance during rotation of the medium 1 for analysis. In FIG. 1, the analysis parts 3 are formed in plurality being arranged in the rotational direction, and the liquid storage parts for respective parts are connected by a liquid feeding passage 9. A fluid specimen injection port 7 and an air drain port 8 are disposed respectively to the both ends of the liquid feeding passage 9. With such a constitution, a plurality of analyzing processings can be conducted at once for an identical fluid specimen.

The substrate 2 is formed of a transparent resin such as polycarbonate (PC). The substrate 2 may be formed of one plate member or may be formed by bonding two or more plate members. Referring to the shape, the substrate is in a disk like configuration of about 12 cm diameter in this embodiment but it is not restricted so long as the substrate is rotatable. “Formed rotatably” means herein that the substrate is formed rotatably around an axis extending vertically to the plane of the substrate 2 as a rotational axis.

The analysis part 3 and the liquid feeding passage 9 are formed on the surface or in the inside of the substrate 2. In a case of forming the analysis part 3 and the liquid feeding passage 9 on the surface of the substrate 2, they can be formed by coating an ultraviolet curing resin or the like to the surface of the substrate by a method of screen printing, metal mask printing, or the like to form a pattern and bonding a resin film or the like on the pattern. In a case of forming the analysis part 3 and the liquid feeding passage 9 in the inside of the substrate 2, this can be formed by injection molding a resin such as PC using a die formed with a pattern thereby forming the substrate 2 formed with a pattern-shaped concave portion and closing the concave portion by bonding a resin film or another substrate. The inner diameter of the channel 5 in the analysis part 3 is about 50 to 500 μm which can be set properly while considering the surface tension or the like of the fluid specimen to be used. A fluid specimen injection port 7 and an air drain port 8 are formed to both ends of the liquid feeding passage 9 by aperturing or a die. It is desirable that the fluid specimen injection port 7 and the air drain part 8 are formed at positions on the inner circumferential side to the analysis part 3 and the liquid feeding passage 9, such that the fluid specimen is not jetted out during rotation.

The operation of the medium for analysis is to be described with reference to FIG. 2. FIG. 2 is an enlarged view for the analysis part 3 in FIG. 1 (dotted part). A fluid specimen LS injected from the fluid specimen injection port 7 is injected to the liquid storage part 4. The fluid specimen LS injected to the liquid storage part 4 slightly intrudes into the channel 5. However, since the channel 5 is closed at the final end where air is present, a gas storage part 6 is formed. The fluid specimen LS injected from the fluid specimen injection port 7 is injected through the liquid feeding passage 9 to another liquid storage part. In this case, a gas stored in the gas storage part 6 is air, but nitrogen may sometimes be stored in a case where it is conducted for example, in a nitrogen atmosphere.

Then, the medium 1 for analysis after completion of the injection of the fluid specimen LS is rotated to generate a centrifugal force. Then, the fluid specimen LS in the liquid storage part 4 flows in the channel 5 by a driving force LF generated by the centrifugal force. The air in the gas storage part 6 is compressed by the fluid specimen LS. This generates a force EF for repelling the fluid specimen LS and the flow of the fluid specimen LS stops at the point where the driving force LF and the repelling force EF are balanced.

Then, when the rotational speed of the medium for analysis is increased, the driving force LF increases along with increase of the centrifugal force and the fluid specimen LS flows further to the depth of the channel 5. However, when the rotational speed is decelerated, since the centrifugal force decreases to weaken the driving force LF, the fluid specimen LS flows backwardly by the repelling force EF toward the liquid storage part 4.

An example of the processing using the function and the effect as described above includes centrifugation. For example, blood is used as the fluid specimen LS, which is injected into the liquid storage part 4. The medium for analysis is rotated to flow the blood into the channel 5. Centrifugation is conducted at a constant rotational speed to separate the blood into blood cells and plasmas. Then, the rotational speed is gradually decelerated to flow the plasmas backwardly to the liquid storage part 4 since heavier blood cells remain in the channel 5, the blood cells and the plasmas can be separated.

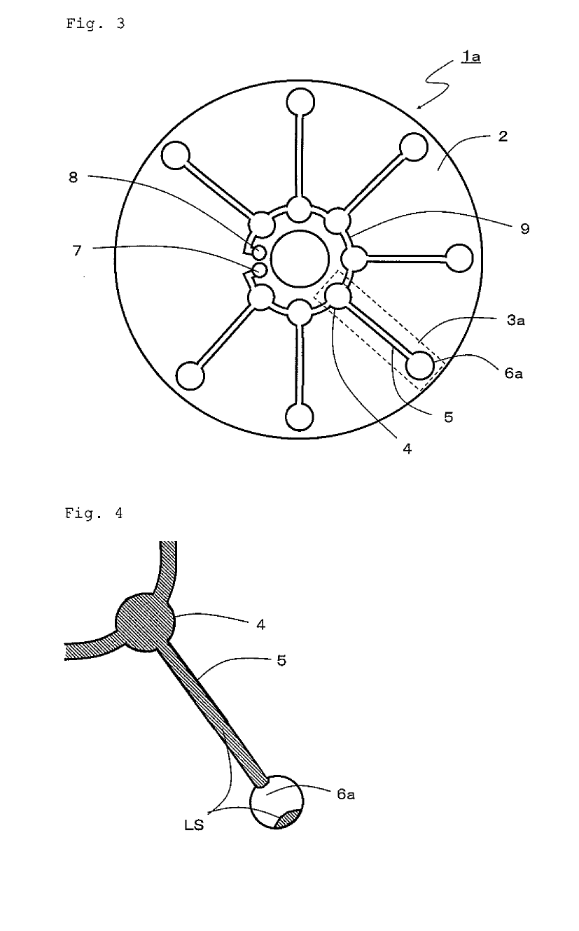

Then, a second embodiment of the invention is to be described. FIG. 3 is a plan view schematically showing the second embodiment of the medium for analysis. The medium 1a for analysis shown here is different from the first embodiment in that an analysis part 3a having a gas storage part 6a having a width larger than that of the channel 5 at the final end of the channel 5 is formed. Since the gas storage part 6a is formed to a width larger than the channel 5, the amount of air to be stored increases and the margin for compression by the flow of the fluid specimen increases, more fluid specimen can be caused to flow and, further, the volume of the fluid specimen to flow backwardly can be increased by so much.

Further, another function and effect due to the structure are to be described with reference to FIG. 4. FIG. 4 is an enlarged view of the analysis part 3a (dotted line part) in FIG. 3. The medium 1a for analysis is rotated to generate a centrifugal force to flow the fluid specimen LS into the channel 5. When the fluid specimen LS reaches the gas storage part 6a, a portion of the fluid specimen LS enters into the gas storage part 6a. Even when the rotational speed of the medium 1a for analysis is decelerated to flow the fluid specimen LS in the channel 5 backwardly, a portion of the fluid specimen LS intruded into the gas storage part 6a does not flow backwardly but remains as it is in the gas storage part 6a. A portion of the fluid specimen LS can thus be remained.

The processing of applying the function and the effect described above includes a case, for example, of separating a centrifugally separated product present in a state of a solution. The fluid specimen LS is separated into a solution of a heavy substance and a solution of a light substance in the channel 5 by centrifugation. Further, the rotational speed of the medium for analysis 1a is increased so as to reach the solution of the heavy substance to the gas storage part 6a. When the solution of the heavy substance has entirely intruded into the gas storage part 6a, the rotational speed is decelerated to flow the solution of the lighter substance backwardly to the liquid storage part 4. The solution can thus be separated.

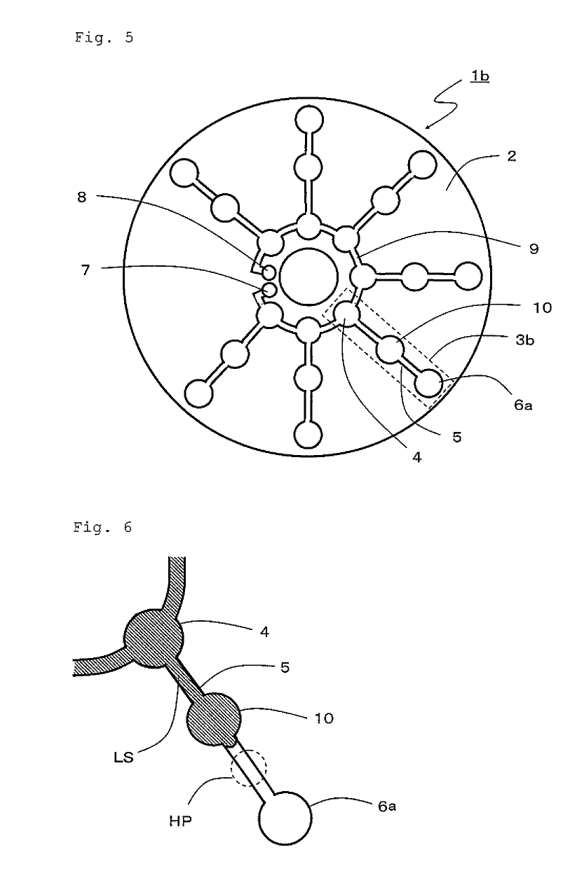

Then, a third embodiment of the invention is to be described. FIG. 5 is a plan view schematically showing the third embodiment of a medium for analysis. The medium for analysis 1b shown herein is different from the second embodiment in that a retainer portion 10 for staying a fluid specimen between a liquid storage part 4 and a gas storage part 6a is formed. Since the retainer portion 10 is formed to a width larger than that of the channel 5, the fluid specimen intruded therein can be retained so as not to flow backwardly. Further, various reactions can also be conducted by staying the fluid specimen in the retainer portion 10. Further, the reacted specimen can be measured in the retainer portion 10. While the retainer portion 10 is disposed at one position in the drawing, it may be disposed optionally at plural positions.

An analyzing processing applying the constitution described above is to be explained referring to an example of a polymerase chain reaction (PCR) method. The PCR method is a method of selectively amplifying a specified DNA present by a micro amount in the specimen, and DNA amplified thereby can be analyzed and utilized as a chemically single substance. A process for the PCR reaction process is divided into three stages of (a) a dissociation stage to an aimed single chain DNA of a template DNA, (b) a double chain formation stage of the single chain DNA and oligonucleotide (primer DNA) having a double chain forming ability to a specified sequence selected on the template DNA, and (c) a DNA extension reaction stage from the terminal portion of the double chain formed primer DNA as an initiation point, and the one process is conducted repetitively for plural times. Among them, the stage (a) is conducted under heating at a relatively high temperature and the stages (b) and (c) are conducted at a relatively low temperature without heating. Accordingly, in the PCR method, it is necessary to subject the sample solution to a heat cycle of repeating high temperature and low temperature alternately. In the existent medium for analysis, a channel formed in a meander configuration was used and the sample solution is passed through in the high temperature area and the low temperature area alternately, for example, as shown in JP-A No. 2005-295877.

An example of DNA amplification by the PCR method using the medium for analysis is to be described with reference to FIG. 6. FIG. 6 is an enlarged view for the analysis part 3b in FIG. 5 (dotted line part). As the fluid specimen LS, an aqueous solution formed by mixing a template DNA, a primer DNA, a thermoresistant DNA polymerase, and a nucleotide as a substrate for the DNA polymerase is provided, which is injected to the liquid storage part 4. Then, the medium for analysis is rotated, the fluid specimen LS is caused to flow into the channel 5 and, further, caused to flow as far as the retainer portion 10. The fluid specimen LS is filled in this step to the retainer portion 10.

Then, the rotational speed of the medium for analysis is further accelerated to flow the fluid specimen LS to the heating area HP. The heating area HP is an area heated locally by a laser radiation or heating means such as a heater disposed to the analyzer so that the area can be heated. By heating the fluid specimen LS in the heating area HP, the template DNA in the fluid specimen LS is dissociated into a single chain DNA.

Then, the rotational speed of the medium for analysis is decelerated to flow the fluid specimen LS backwardly to the retainer portion 10. Thus, the single chain DNA is delivered to the retainer portion 10. Since the retainer portion 10 is a non-heating area, double chain formation and DNA extension reaction with the primer DNA that are taken place under low temperature occurs. Thus, the template DNA is replicated in the retainer portion 10.

Then, the rotational speed is again accelerated to flow the fluid specimen LS in the retainer portion 10 into the heating area HP. By repeating the acceleration and deceleration of the rotation of the medium for analysis, since the fluid specimen LS can be passed alternately between the heating area and the non-heating area, a heat cycle can be formed, The number of the heat cycle was restricted so far by the meander frequency of the channel. However, since the heat cycle is repeated by repeating the acceleration and deceleration, it can be theoretically repeated by an infinite number of cycles. Further, also for the period of the heat cycle, while it was necessary to control by the speed of flowing the fluid specimen to the channel in the existent method, since this can be controlled by the period of acceleration and deceleration, the PCR method can be conducted by a more simple method than usual.

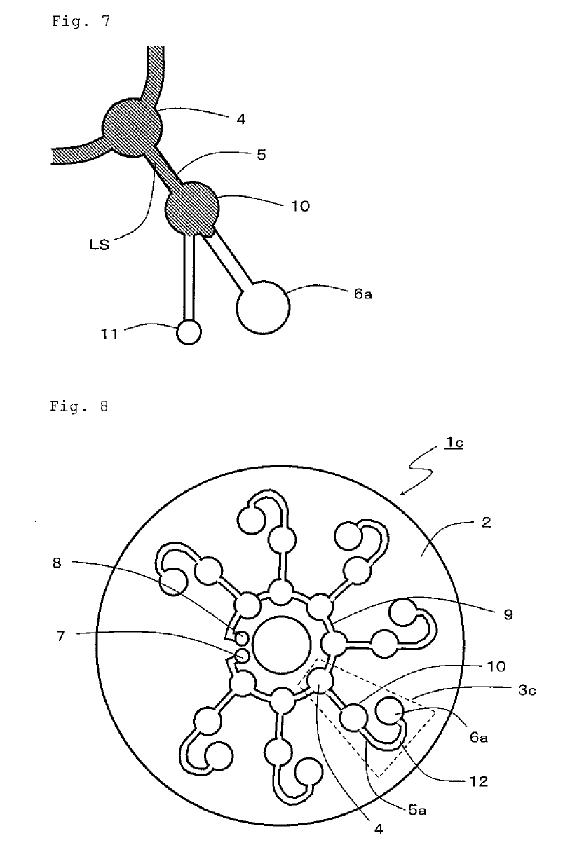

For the retainer portion 10, a reagent injection part 11 may also be provided as shown in FIG. 7, The reagent injection part 11 is effective in a case of conducting reaction using reagents which are different for each of the analysis parts. For example, in a case of the PCR method described previously, the kind of the DNA to be amplified in each of the analysis parts can be changed by injecting the primer DNA from the reagent injection part 11, and plural kinds of DNA can be amplified at once. The reagent injection part 11 may be closed, for example, by melting with laser radiation or sealing with a seal and the like after the injection for the reagent. Further, the reagent injection part 11 can be utilized, in addition to the injection for the reagent, also as a collection port for sampling the fluid specimen LS after reaction stored in the retainer portion 10.

Then, a fourth embodiment of the invention is to be described. FIG. 8 is a plan view schematically showing a forth embodiment of the medium for analysis. The medium for analysis 1c shown herein is different from the third embodiment in that it has a channel 5a in which a bend section 12 is provided between the liquid storage part 4 and a gas storage part 6a.

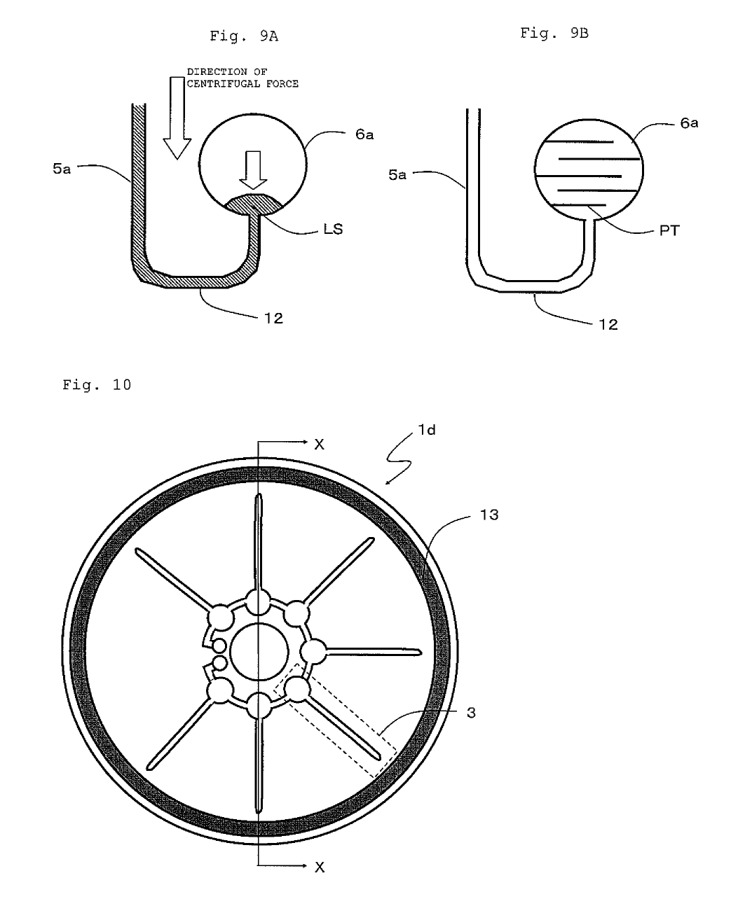

The function of the bend section 12 is that the fluid specimen LS intruded into the gas storage part 6a can be retained near the inlet of the gas storage part 6a by a centrifugal force as shown in FIG. 9A. By retaining the fluid specimen LS near the inlet port, the fluid specimen LS in the gas storage part 6a can also be caused to flow backwardly upon backward flow. In a case where the inside of the gas storage part 6a has a good wettability to the fluid specimen LS, the fluid specimen LS may sometimes intrude along the surface of the inside of the gas storage part 6a and may sometimes detach from the inlet. In such a case, the fluid specimen LS can be retained near the inlet by disposing partitions PT in the inside of the gas storage part 6a as shown in FIG. 9B. While description has been made to the gas storage part 6a, the same effect can also be obtained in a case of replacing the gas storage part 6a with the retainer portion 10.

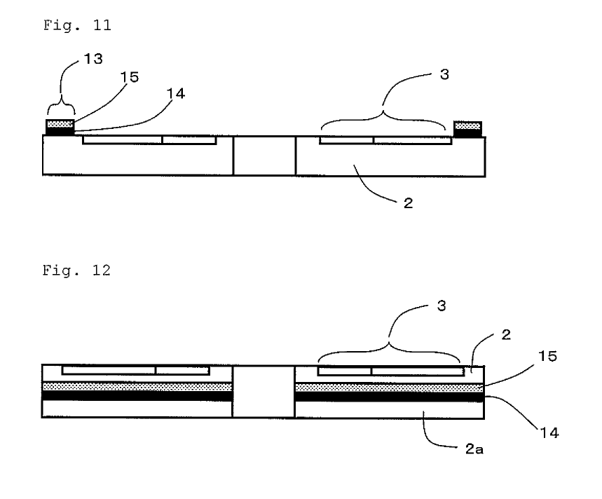

Then, a fifth embodiment of the invention is to be described. FIG. 10 is a plan view schematically showing the fifth embodiment of the medium for analysis. FIG. 11 is a schematic cross sectional view of a medium 1d for analysis along line X-X in FIG. 10. In the medium 1d for analysis shown in FIG. 10, an information recording part 13 is formed to a region not formed with the analysis part 3. The information recording part 13 can record information by a laser light like in CD-R, etc., and has a recording layer 14 constituted with a dye or the like and a reflective layer 15 for reflecting light as shown in FIG. 11. Although not illustrated, a protective layer is formed optionally. While the information recording part 13 is formed in the outer periphery to the analysis part 3 in FIG. 10, it may be formed in the inner periphery thereof.

The information recording part 13 is used for recording the result of measurement and analysis using the medium 1d for analysis. Further, a program for operation such as for the timing of acceleration and deceleration and the magnitude of the acceleration of the rotational speed of the analyzer using the medium for analysis by a predetermined procedure can be written into the information recording part 13.

A further embodiment of the medium for analysis includes a medium for analysis as shown in FIG. 12 in which a substrate 2 formed with an analysis part 3 and a substrate 2a formed with a recording layer 14 and a reflective layer 15 as the information recording part are bonded to each other. This is the same structure as that of DVD±K, and identical recorder, recording method, etc, can be used. Since the information recording part is on the surface opposite to the analysis part, it does not interfere with the analysis part.

The foregoing embodiments are applicable to microanalysis or microsynthesis and microanalysis in medical, biological, and chemical fields. These embodiments are not restricted to the application use illustrated in the description of the preferred embodiments but is applicable also for various measurements and analyses.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A medium for analysis comprising:
an analysis part formed on the surface of or inside a substrate, the analysis part comprising:
a liquid storage part configured to store a fluid specimen; and
a channel extending from the liquid storage part in the centrifugal direction, wherein the final end of the channel is closed, and a gas storage part containing gas at the final end of the channel upon injection of the fluid specimen in the liquid storage part is formed.

2. The medium for analysis according to claim l, wherein the medium comprises two or more analysis parts, and wherein the liquid storage part of at least one of the analysis parts is connected to the liquid storage part of another of the analysis parts by a liquid feeding passage.

3. The medium for analysis according to claim 1, wherein the gas storage part comprises a space of a width larger than that of the channel.

4. The medium for analysis according to claim 1, wherein the medium comprises a retainer portion formed between the liquid storage part and the gas storage part, the retainer portion being configured to stay the fluid specimen.

5. The medium for analysis according to claim 4, the medium further comprises a reagent injection part connected to the retainer portion.

6. The medium for analysis according to claim 1, wherein the channel between the liquid storage part and the gas storage part comprises a bend section.

7. The medium for analysis according to claim 1, wherein an information recording part is formed in a region of the substrate where the analysis part is not formed.

8. A method of flowing a fluid specimen comprising:
placing a fluid specimen into a channel extending in a centrifugal direction on a medium; and
controlling the position of the fluid specimen by balancing centrifugal force with an opposing gas pressure force

9. The method of claim 8, further comprising decelerating the rotational speed of the medium thus causing the fluid specimen in the channel to flow backwardly.

10. The method of claim 8, further comprising:
accelerating and decelerating the rotational speed of the medium alternately.
